(19) United States
(12) Patent Application Publication
(10) Pub. No.: US 2026/0154991 A1
(43) Pub. Date: Jun. 4, 2026

(54) PARKING AND ADVERTISING SYSTEM

(71) Applicant: Proximity Parking, Inc., Newport, KY (US)

(72) Inventors: Grant Murray, Newport, KY (US); Patrick Parker, Newport, KY (US); Jonathan Dever, Newport, KY (US)

(21) Appl. No.: 19/406,129

(22) Filed: Dec. 2, 2025

Related U.S. Application Data
(60) Provisional application No. 63/726,955, filed on Dec. 2, 2024.

(51) Int. Cl. G07B 15/02; G06Q 30/0251

(52) U.S. Cl. CPC G07B 15/02; G06Q 30/0259

(57) ABSTRACT

Methods and systems are described for a parking and advertising system. A consumer may approach a locale with various parking options, be notified of available parking spaces, pay for the parking space, receive marketing materials for businesses nearby, activate point of sale functionality and perform other tasks. Data collected related to parking or purchases may be collected and analyzed, including through AI/ML functionality in order to optimize variables, such as marketing approaches.

### CROSS REFERENCE TO RELATED INFORMATION

This application claims the benefit of United States of America priority application No. 63/726,955 filed on Dec. 2, 2024, titled “Parking and Advertising System,” the contents of which are hereby incorporated herein in its entirety.

### TECHNICAL FIELD

The present disclosure generally relates to systems and methods for integrating parking payments and advertising.

### BACKGROUND

It may be common for consumers to pay for parking and then walk around a given shopping mall, neighborhood, or other location. In these situations the local businesses don't know who may be parking (potential customers) and are unable to target such individuals for advertising, coupons, etc.

### SUMMARY

One embodiment under the present disclosure comprises a parking and advertising system. The system comprises a processor; and a memory storing instructions. The instructions can cause the processor to perform the steps of: detect or predict a location of a consumer; transmit, to a device of the consumer, a notification of one or more available parking spaces near the location; receive, from the device, a selection of a parking space of the one or more available parking spaces; receive, from the device, one or more payment information to pay for the parking space; and transmit, to the device, one or more marketing materials related to one or more businesses near the location.

Another embodiment under the present disclosure comprises a method performed by a parking and advertising system. The method comprises: detecting or predicting a location of a consumer; transmitting, to a device of the consumer, a notification of one or more available parking spaces near the location; receiving, from the device, a selection of a parking space of the one or more available parking spaces; receiving, from the device, one or more payment information to pay for the parking space; and transmitting, to the device, one or more marketing materials related to one or more businesses near the location.

Another embodiment under the present disclosure may be a computer implemented method for training a machine learning model for optimizing parking and/or advertising to consumers. The method comprises: obtaining a first dataset of identified parking and/or advertising outcomes; training the machine learning model using the first dataset of identified parking and/or advertising outcomes thereby obtaining a trained machine learning model, and storing the trained machine learning model.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates one embodiment of a parking/advertising system under the present disclosure;

FIG. 2 illustrates one embodiment of a user interface for a parking/advertising application under the present disclosure;

FIG. 3 illustrates a possible parking/advertising server under the present disclosure;

FIG. 4 illustrates a possible parking/advertising server under the present disclosure;

FIG. 5 illustrates a possible parking/advertising server under the present disclosure;

FIG. 6 illustrates a possible parking/advertising server under the present disclosure;

FIG. 7 illustrates a possible parking/advertising server under the present disclosure;

FIG. 8 shows an example flow chart of training and inference pipelines for machine learning in accord with some embodiments under the present disclosure;

FIG. 9 shows an embodiment of a neural network under the present disclosure;

FIG. 10 shows an embodiment of a computing device for use in various embodiments under the present disclosure;

FIG. 11 illustrates a flow-chart of a method embodiment under the present disclosure;

FIG. 12 illustrates a flow-chart of a method embodiment under the present disclosure;

FIG. 13 illustrates a flow-chart of a method embodiment under the present disclosure;

FIG. 14 illustrates a flow-chart of a method embodiment under the present disclosure;

FIG. 15 illustrates a flow-chart of a method embodiment under the present disclosure;

FIG. 16 illustrates a flow-chart of a method embodiment under the present disclosure;

FIG. 17 illustrates a flow-chart of a method embodiment under the present disclosure;

FIG. 18 illustrates a flow-chart of a method embodiment under the present disclosure;

FIG. 19 illustrates a flow-chart of a method embodiment under the present disclosure; and

FIG. 20 illustrates a flow-chart of a method embodiment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges in the realm of parking and advertising. Small or local businesses have trouble competing with the large entities, such as Amazon™. They also have very few ways to identify people that are in the local vicinity, because they work nearby, or are visiting temporarily, etc.

Certain aspects of the embodiments disclosed herein provide solutions to these or other challenges. Certain embodiments include system and methods for providing payment for parking garages/lots, as well as identifying potential customers from amongst parked vehicles/people, and transmitting target advertising to such individuals.

Certain embodiments may provide one or more of the following technical advantages. Embodiments can achieve greater tailoring of advertisement generation and/or marketing to consumers most likely to consume such content. Certain embodiments can collect large amounts of data to help in optimizing future content by style, industry, consumer preference, and/or other factors.

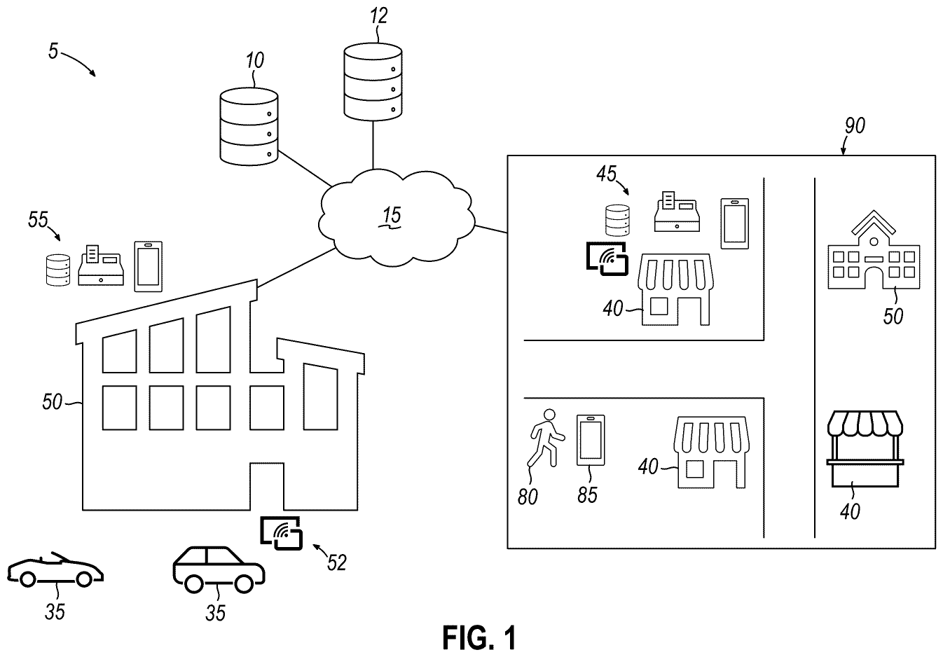

Referring now to FIG. 1, one embodiment of a parking/advertising system 5 is shown. Parking location 50 (e.g., garage, lot, street parking space, or other types of parking spots) may be located at a locale 90 (such as a neighborhood, town, downtown, shopping center, etc.). Cars 35 with consumers 80 may park in the parking location 50 and consumers 80 may walk to stores 40 (or businesses, offices, tourist attractions, etc.). Parking location 50 may comprise computing devices 55 (such as servers, point of sale devices, card readers, smart devices, payment terminals, wireless routers, wireless networks, Bluetooth devices, NFC devices, combinations of the foregoing, etc.) which may process, record, and/or receive payments (e.g., cash, credit card, Apple Pay, Google Pay, or a variety of other payment methods or types). Similarly, stores 40 may comprise computing device 45 (such as servers, point of sale devices, card readers, smart devices, payment terminals, wireless routers, wireless networks, Bluetooth devices, NFC devices, combinations of the foregoing, etc.) which may process, record, and/or receive payments (e.g., cash, credit card, Apple Pay™, Google Pay™, or a variety of other payment methods or types). Consumer 80 may carry and otherwise use a smart device 85 (e.g., smartphone, smartwatch, tablet, etc.). Parking/advertising server 10 may collect, track, process, and/or otherwise manipulate various data within parking/advertising system 5, such as payment data at parking location 50, advertising sent to consumer 80 at smart device 85, purchases at stores 40, and/or other data. Network 15 may provide communicative coupling amongst, or other telecommunications functionalities for, the various devices of system 5, such as e.g., parking/advertising server 10, computing devices 55, computing devices 45, smart device 85, cars 35, etc. Network 15 may comprise e.g., the Internet, cellular, Bluetooth™, Wi-FI, satellite, enterprise, private network, similar networks, and/or combinations of the foregoing. Certain embodiments may use Cellular and/or Wi-Fi to track locations of consumer 80, and Bluetooth and/or NFC to implement payment functionalities at stores 40. However, a variety of embodiments are possible. Third party server(s) 12 can comprise server(s) for Apple™, Google™, loyalty point servers, and/or other third party servers. These may provide integration with e.g. Apple Wallet, Google Wallet, or other third-party functionalities.

In one embodiment of system 5, when consumer 80 parks car 35 at parking location 50, they may use an application on smart device 85 to pay (they may have an application downloaded from e.g., parking/advertising server 10), they may scan a QR code posted in parking location 50, navigate a browser on smart device 85 to a payment website, or other methods or means. Scanner 52 (or a toll booth manned by a worker) may scan a credit card, QR code on smart device 85, barcode on smart device 85, or take a picture of a license plate (which can be associated with an account of consumer 80). Payment/advertising server(s) 10 detects what parking location 50 consumer 80 parked at, may store and track an address/location of consumer 80 or car 35 on an ongoing basis, and can detect what stores 40 are nearby (via e.g., communication with scanner 52 and/or computing devices 55). Payment/advertising server 10 can transmit advertising messages (e.g., mobile application notifications, SMS messages, browser popups, etc.) to smart device 85 with incentives for consumer 80 to visit stores 40. In some embodiments the advertising messages can come straight from e.g., computing devices 45 associated with a store 40.

In certain embodiments it is unnecessary for consumer 80 to use or be associated with any parking location 50. Described proximity-based advertising functionalities can be implemented regardless of consumer 80 driving, walking, etc. Parking-related functionalities are just one method of delivery possible under the present disclosure. In other embodiments of system 5, consumer 80 may not park a car, but is located within, or approaching, locale 90. For example, in some cities it is common to not use a car. In certain embodiments consumer 80 may be walking, or riding a bike, taxi, subway, scooter, or other transportation means. Payment/advertising server(s) 10 can detect that consumer 80 is near/approaching/within locale 90, and what stores 40 are nearby. Payment/advertising server 10 can transmit advertising messages (e.g., mobile application notifications, SMS messages, browser popups, etc.) to smart device 85 with incentives for consumer 80 to visit stores 40. In some embodiments the advertising messages can come straight from e.g., computing devices 45 associated with a store 40.

Parking/advertising server 10 may track, collect, or otherwise access user data about consumer 80, such as age, sex, income, purchasing history, or other data, and this data may be used in the processing of transmitting advertising messages. Greater information about consumer 80 may be collected from (after receiving the necessary permissions where applicable), browser history, Google/Facebook (or other provider) account data, scans of email inboxes, data collected from previous parking sessions, types of applications on the smart device 80, or other sources. In one example, a high-income individual may receive different advertising for different stores than another customer. In another example, a consumer 80 with a Google search history related to health food may be targeted by a local business that focuses on such foods. Time of day may also impact what advertisements are shown to consumer 80: coffee advertisements may be more common in the morning, restaurant advertisements around lunchtime, etc. Certain embodiments can utilize or access a variety of data sources to refined targeted advertising, including but not limited to: consumer purchase history, web browser history, comprehensive location history (including but not limited to parking locations) and other data sources that may be able to enhance analysis of consumer behavior or preferences or location information about e.g., locale 90. In certain embodiments, various data sources can be used to make highly accurate context-specific advertising recommendations. National or local privacy laws, such as GDPR (General Data Protection Regulation) or CCPA (California Consumer Privacy Act), may limit the types of data sources that can be used for targeted advertising.

Smart device 85 may also enable location tracking of consumer 80 e.g., through an application or browser. Via location tracking the payment/advertising server 10 may be able to detect consumer 80 location within locale 90. In this way, specific stores 40 near consumer 80 can be notified as to their location for possible advertising opportunities. Other embodiments can track the consumer 80 location and deliver advertisements for local businesses even if a parking session hasn't been used. For example, consumer 80 may work in locale 90 and may be targeted for advertisements for local restaurants, coffee shops, etc.

Other embodiments of system 5 can allow for greater tracking of parking availability and notifications to consumer 80 of available parking spaces and, once parked, reminders of parking location. In one example, consumer 80 may approach locale 90 in car 35. Consumer 80 can open the application and request or search for available parking spots. Parking/advertising server 10 may track open and taken parking spots in parking locations/lots 50 and can notify consumer 80 of specific available parking spots and give directions to such spots.

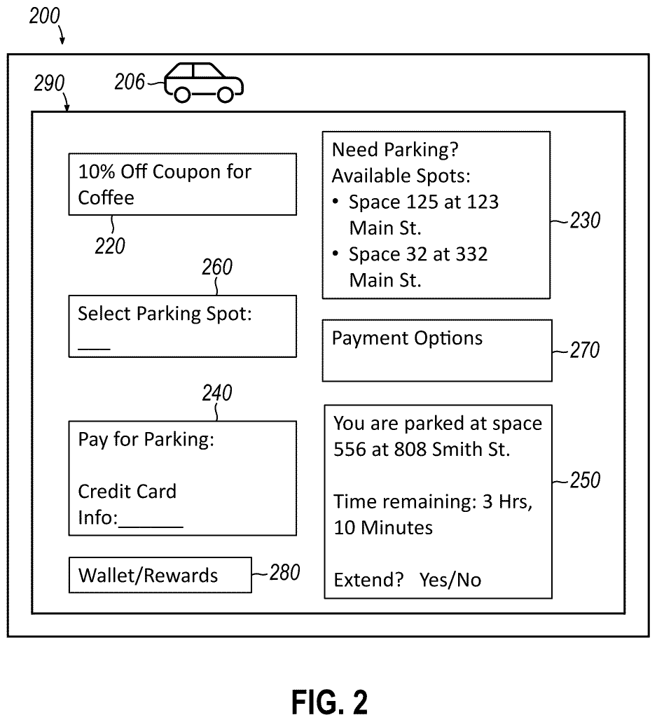

FIG. 2 illustrates aspects of possible embodiments of a parking application 200 with user interface (UI) 290 under the present disclosure. Application 200 can be used in e.g., smart device 85 of FIG. 1, such as smartphones, tablets, etc. Application 200 can be offered by, or downloaded from, e.g., parking/advertising server 10, or from other application stores. Application 200 can offer functionalities such as coupons 220, parking finder 230, payment 240, and parking information 250. With continuing reference to FIG. 1, consumer 80 may arrive at locale 90 in car 35. Consumer 80 may open application 200 and select parking finder 230. Parking finder 230 can detect the location of consumer 80 (e.g., via GPS (Global Positioning System) or cellular location functionality) and indicate available parking spaces at locations 50 in locale 90. Consumer 80 may direct car 35 to one of the indicated parking spaces. Consumer 80 can then select a parking space where they have parked in spot identification 260 (e.g., via text entry, scanning a QR code, or other means). Consumer 80 can then select payment 240 to enter payment information, such as e.g., credit card information, Apple Pay, Google Pay, etc. In some embodiments, consumer 80 may use smart device 85 to pay at a kiosk at location 50, e.g., via NFC (near field communication). Once parked and paid, application 200 may provide parking information 250, such as where consumer 80 parked, time left, options to extend their parking session, or other information. Consumer 80 can also be presented with marketing material 220 (e.g., advertisements, coupons, etc.), upon parking or while walking around locale 90 as described with respect to FIG. 1. These functionalities can be presented to consumer 80 while opening and/or using application 200. In other embodiments, consumer 80 may receive a notification 206 on their smart device 85 that indicates, e.g., available coupons 220, time expiring on the parking spot in parking information 250, or other information.

Delivery of marketing material 220 can occur after consumer 80 has parked, but it could also be accomplished at other times, such as when consumer 80 opens application 200 to find parking at locale 90, or any appropriate time to target consumers with marketing material.

Application 200 can also offer payment options 270 for use in payment at e.g., stores 40 of FIG. 1. For example, codes, QR codes, Apple Pay information, gift card information, or other payment mechanisms can be integrated to entice or simplify payment at stores 40, such as via a point of sale device at stores 40. This can also help application 200 to track purchases by consumer 80, and enhance measurement and analysis of the success of marketing material 220. Certain embodiments can comprise an electronic wallet 280, e.g., within application 200, that can function as a payment and/or rewards tool. Wallet 280 could be used as a preloaded wallet (e.g., previously funded by e.g., credit card, Paypal™, or other means) that consumers could use for purchases at local stores. Rewards from previous purchases could also be aggregated within wallet 280 and could include funds for future purchases. Benefits of this functionality can include, e.g., streamlining of payments at affiliated stores, enabling of loyalty rewards as an additional incentive structure to drive business using targeted advertisements, enabling of incentives to use affiliated parking locations 50. Other benefits can include offering a measurable way to track advertisement success by linking targeted advertisements to in-store purchases. Additional commission can be collected on such sales as well. In addition, linking targeted advertisements with location-enhanced systems and/or predictive advertising can help drive increased sales and traffic to stores 40 or locale 90 of FIG. 1.

While the description in FIGS. 1 and 2 have focused on car parking, the present disclosure is not so limited. The present disclosure can be extended to parking of any vehicle, including bicycles, motorcycles, boats, aircraft, self-driving vehicles, and others. For example, some cities encourage bicycles over car use, and locations 50 of FIG. 1 could comprise storage or locking locations for bicycles. In other examples, locale 90 or locations 50 could comprise a marina, dock or other location for travel and/or parking/storage of boats and other watercraft.

Referring again to FIG. 1, certain embodiments of the present disclosure can allow for tracking and data analysis with regards behavior of consumer 80. For example, parking/advertising server 10 can track various data, e.g., parking behavior, parking length, home address of consumers 80, purchasing behaviors of consumers 80, purchases at stores 40, payment types used, success of different types of marketing material 220, location 50 performance, time of day of purchases at stores 40, and a variety of other data. Some of this data can be collected by direct collection from application 200, point of sales devices (e.g., computing devices 45), by accessing browser or other user information on smart device 85, or other means.

Certain embodiments of system 5 can include automated enforcement capabilities. For example, parking locations 50 can detect when consumer 80 has started a parking session, how long a session that consumer 80 was charged, send notifications (e.g., by computing devices 55, or parking/advertising server 10) to consumer 80 related to the parking session (e.g., time remaining, options for extending, when parking location 50 closes, etc.), and/or enforce parking violations. For example, computing devices 55 or parking/advertising server 10 may detect that the consumer 80 has not returned to their car and can apply a parking ticket, additional parking fee, or other enforcement mechanism or penalty to the account of consumer 80. Certain embodiments of automated enforcement can include tracking of location of consumer 80 via parking/advertising server 10, smart device 85, and/or other location tracking mechanisms that allow parking/advertising server 10 or computing devices 55 to detect that consumer 80 has not returned to their car, bike or other vehicle. Data from computing devices 45 at stores 40 can also be used to determine location of consumer 80. Certain embodiments of automated enforcement can include e.g., issuing a violation if the parking session expires (regardless of a location of consumer 80), automatically adding additional time to the parking session if consumer 80 opts for it, notifying an enforcement agent (e.g., police, security, or other parking authority), or other actions. Certain embodiments of automated enforcement can improve operational efficiency for parking managers and increase parking-related revenue. This can bring extra value to the monitored or tracked location or purchase data from e.g., stores 40.

Certain embodiments can comprise predictive delivery of targeted advertisements. For example, parking/advertising server 10 may track the location of consumer 80 during their entire day or may know from a location history of consumer 80 that consumer 80 goes to e.g., locale 90 on certain days (e.g., every weekday, every Tuesday, on weekends, etc.). If a consumer 80 is likely to visit a given locale 90 on a certain day, then advertisements can be delivered to consumer 80 or smart device 85 before consumer 80 arrives to locale 90 or parking location 50. For example, in certain embodiments, if data shows a consumer 80 frequently parks in a specific parking location 50 at certain times, a local store 40 could send ads or promotions before the consumer 80 arrives (e.g., a coffee truck advertising their location and specials ahead of time for someone parking at a work location daily). These types of embodiments can enhance predictive advertising as a strategic feature that improves advertisement effectiveness by leveraging behavioral data patterns from a variety of data sources, such as described above with regards to targeted advertising embodiments.

Embodiments under the present disclosure, e.g. system 5 of FIG. 1, can provide a variety of other functionalities. As described above, in certain embodiments a consumer 80 may park car 35 at parking location 50. Consumer 80 may use an application on smart device 85 to “check-in” at parking location 50 (and/or pay). Checking-in can comprise e.g.: scanning a QR code, barcode, or another code displayed on smart device 85; connecting via NFC to scanner 52 or computing devices 55; scanning (by smart device 85) a QR code, barcode, or another code displayed by smart devices 55 or posted at parking location 50; or smart device 85 may detect that consumer 80 has entered parking location 50 via GPS signals, Bluetooth connectivity, or other wireless signals. Smart devices 55, scanner 52, and/or smart device 85 can notify or record the parking session of consumer 80 with parking/advertising server 10. In some embodiments, after checking in consumer 80 may receive a push notification, email, text message, or other communication with a link to a payment website. Or their account can automatically be deducted of parking fees by parking/advertising server 10. Parking/advertising server(s) 10 can detect what parking location 50 consumer 80 parked at, and what stores 40 are nearby, for sending of advertisements, coupons, etc.

In some embodiments, after checking in consumer 80 may receive a link to a pass (e.g. a parking ticket) in an Apple wallet, Google wallet, or other digital wallet or wallet system. Integrating with a digital wallet such as Apple or Google wallet can allow for push notification functionality via the Apple or Google system. Integration with Google Wallet or Apple Wallet may be achieve through integration with e.g., third-party server(s) 12 of FIG. 1. Integration with e.g., Apple wallet or Google wallet can be e.g. via reward/wallet 280 of application 200, shown in FIG. 2.

In some embodiments, a consumer 80 may receive a parking ticket for parking in the wrong space, parking in a space too long, or other parking violations. Parking/advertising server(s) 10 can detect, or receive a notification (from police, parking location 50, other source) of the violation, and can send consumer 80 or smart device 85 a notification of the violation. Consumer 80 can receive a notification of the violation via push notification (e.g. Apple wallet), text message, email, or other communication means. The notification may include an option for consumer 80 to visit a website, or provide a code (QR, barcode, other) to a physical store, to spend a certain amount of money at certain stores in lieu of paying a parking fine.

In some embodiments, smart device 85 (and/or parking/advertising server(s) 10) can perform location tracking of consumer 80 via GPS on smart device 85 or other location tracking means. Location tracking could be done by detecting consumer 80 or smart device 85 in various locations 40 via Wi-Fi networks, Bluetooth networks, smart devices 45, payment kiosks, and/or other devices. Parking/advertising server(s) 10 and/or smart device 85 may detect how far consumer 80 has traveled, and/or calculate how long it may take to return to parking location 50. Parking/advertising server(s) 10 and/or smart device 85 may provide a notification of the travel/walk time to return to the parking location, and/or pay for more parking automatically (depending on the preferences of consumer 80).

Location tracking of consumer 80 can also be used to direct target advertisements to consumer 80. For example, parking/advertising server(s) 10 and/or smart device 85 may detect that consumer 80 has entered or approached a store/hotel/mall/athletic event/etc., and then directs advertising (coupons/gift cards/other enticements) to consumer 80 based on that location.

Parking/advertising server(s) 10 and/or smart device 85 (and system 5 of FIG. 1 generally) can enable a variety of loyalty-based rewards and payment options or loyalty tracking. For example, parking/advertising server(s) 10 and/or smart device 85 may integrate with loyalty or reward-based credit cards, store loyalty points, or other types of loyalty or reward tracking systems. Third-party server(s) 12 can comprise credit card servers, loyalty point servers, or other loyalty or reward servers associated with a third party. Purchases (parking, at locations 40, or other purchases) may allow consumer 80 to accrue reward or loyalty points associated with a credit card, store, or other third party. Loyalty points can in some embodiments be used to pay for parking or other purchases via application 200 or via smart device 85 or associated payment methods, such as with wallet/rewards 280 of application 200, shown in FIG. 2. Loyalty points can be used to validate parking (e.g., through spending at a local store 40), and loyalty points can provide an additional incentive structure to encourage interaction with and utilization of advertisements and offers. For example, if consumer 80 receives an advertisement from a local store 40 then the consumer 80 may earn extra points (e.g., 50 reward/loyalty points) as an additional incentive to click and/or convert advertisements.

As described above, there can be a variety of use case scenarios utilizing system 5 of FIG. 1, application 200 of FIG. 2, and other components and systems described herein. With continuing reference to FIGS. 1 and 2, below are provided several, non-limiting, example use cases of various embodiments under the present disclosure.

### Settling Parking Tickets via Local Business Purchases

Certain use cases can involve allowing users to settle parking tickets by spending at local businesses through a proximity-based ad network, such as system 5 of FIG. 1, leveraging delivery of advertisements via parking transactions and connecting to point of sale (POS) systems. For example, when a user receives a parking ticket (e.g., $25), they can opt to settle it by spending a specified amount at local businesses listed in the advertisement network. The consumer can access offers via the ad network, choosing to shop online or in person. For online purchases, system 5 tracks the purchase through the link, automatically settling the ticket if the amount meets the requirement. For in-person purchases, if the business has an integrated POS, the purchase is verified automatically; otherwise, the user submits a receipt for manual verification by the administrator, city, or other manager or entity.

Certain use cases allow payment of parking violations or tickets. Such use cases can allow consumer 80 to settle parking tickets issued through the parking payment platform by making purchases at local businesses advertised through the advertisement network. Aspects can include:
Parking Ticket Issuance: The system issues a parking ticket to a user, specifying an amount due (e.g., $25).
Settlement Option: Consumer 80 is provided with an option to settle the ticket by spending a specified amount at local businesses 40, rather than paying the ticket directly. This amount could be equal to, more than, or less than the ticket amount, depending on the policy, to incentivize local spending.
Business Listing and Offers: The system presents consumer 80 with a list of participating local businesses 40 and their current offers via the advertisement

network, leveraging the existing infrastructure for targeted advertising based on parking transaction data.
Online Purchase Process: Consumer 80 can click on a link to a business's ecommerce site provided by the ad network. The purchase is tracked through a unique identifier or tracking code in the link. If the purchase amount meets or exceeds the required amount, system 5 or parking/advertising server(s) 10 can automatically verify the transaction and settles the parking ticket, updating the user's account accordingly.
In-Person Purchase with Integrated POS: Consumer 80 visits a local business 40 and makes a purchase. If the business's POS system is integrated with the system 5, the purchase is automatically recorded and verified through the connection. If the purchase amount meets or exceeds the required amount, the ticket is automatically settled, with the system communicating the settlement to the parking/advertising server(s) 10.
In-Person Purchase without Integrated POS: If the business 40 does not have an integrated POS system, consumer 80 can make a purchase and submit a receipt through a system 5 interface. The receipt can include details such as the purchase amount, date, business name, and possibly a timestamp or transaction ID. An administrator or city official can manually verify the receipt to ensure it meets the criteria (e.g., correct business, sufficient amount, within the allowed timeframe). Upon verification, the ticket is settled, and the user is notified. This can encourage consumers 80 to support local businesses 40 while fulfilling their parking obligations, aligning with community economic development goals.

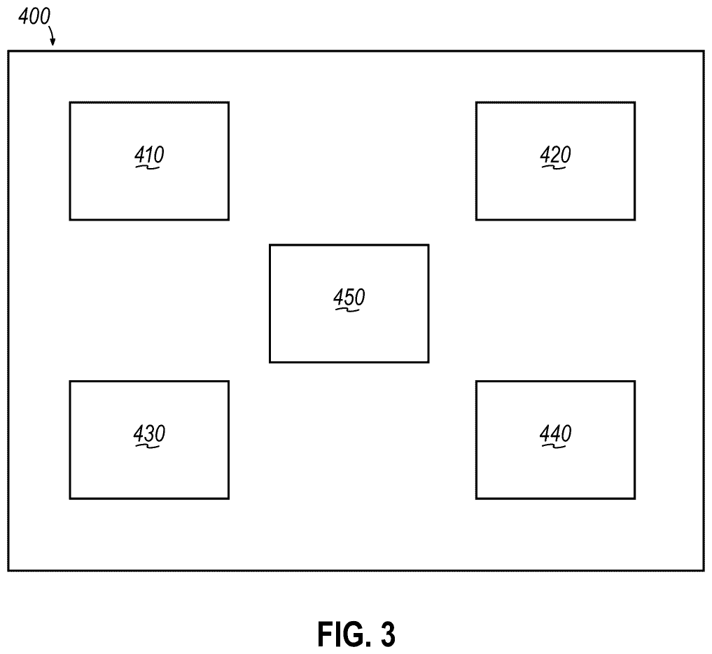

A use case of the preceding embodiment can be implemented as follows:
Issue a parking ticket to consumer 80 with a specified amount due through system 5.
Provide consumer 80 with an option to settle the ticket by making a purchase at a local business 40 through the proximity-based ad network, specifying the required spending amount.
Present consumer 80 with a list of local businesses 40and their offers via the ad network, based on location and consumer data from parking transactions.
If consumer 80 selects an online purchase:
   i. Direct the user to the business's ecommerce site via a tracked link.
   ii. Track the purchase amount using a unique identifier in the link.
   iii. Automatically verify if the purchase amount meets or exceeds the required amount.
   iv. If verified, automatically settle the parking ticket and update the system.
If consumer 80 selects an in-person purchase at a business with an integrated POS system:
   i. Record the purchase amount through the integrated POS system.
   ii. Automatically verify if the purchase amount meets or exceeds the required amount.
   iii. If verified, automatically settle the parking ticket and update the system.
If the user selects an in-person purchase at a business without an integrated POS system:
   i. Allow the user to submit a receipt of the purchase, including amount, date, and business details.
   ii. Manually verify the receipt by an admin or city official to ensure compliance with criteria.
   iii. If verified, settle the parking ticket and update the system.
This use case can be implemented as a system, e.g., parking/advertising server(s) 10. FIG. 3 illustrates one possible embodiments of parking/advertising server(s) 10. Server 400 can comprise parking management module 410 can be used for issuing and tracking tickets. An ad network module 420 can be for listing businesses and their offers, integrated with parking transaction data. A purchase tracking module 430 can be for online purchases via tracked links and POS integration. A verification module 440 can be for automatic (online, integrated POS) or manual (receipt submission) verification. A settlement module 450 can be for updating ticket status upon verification. Such a parking/advertising server can have multiple uses and benefits:
Multiple Purchases: The system could aggregate purchases within a timeframe to meet the required amount, or require a single transaction.
Excess Amount: If the purchase exceeds the required amount, the system could issue a credit or refund, though this might be policy-dependent.
Time Limits: A deadline for settling the ticket via purchases (e.g., 30 days) could be enforced.
Fraud Prevention: Measures like receipt validation or POS integration ensure purchases are genuine.
Business Eligibility: Criteria for businesses (e.g., must be within city limits, offer certain discounts) could be part of the system.

### Location Based Tracking and Automated Parking Enforcement

Certain embodiments can implement location-based tracking an automated parking enforcement. These can include notifying consumer 80 to pay for parking when they enter a geofenced area, reducing forgotten payments. This could also be done integrating with LPR (license plate recognition) technology. When the LPR system catches the license plate of a historical customer, meaning their contact information is collected, they can automatically receive a prompt to pay by sending a link via text/email/other to pay for parking. System 5 can also track their location post-parking to prompt session extensions if they're far from their car, or suggest purchases to extend time. Parking sessions can be automatically started or ended based on movement and/or speed of consumer 80, detected via e.g., their device 85. System 5 can also predict parking violations by analyzing their location and shopping activity, and notifying attendants to enforce tickets if they're likely to overstay.

Further location-based aspects and features include the following.
Detection and Notification for Parking Payment: System 5 can detect when a user enters a geofenced parking area, using their mobile device 85 location data. If the user has previously paid through the system and their data is associated, the system notifies them to pay for parking to reduce forgotten or neglected payments, delivered through the ad network platform. System 5 can be used to track a users license plate upon entry, check the system for that license plate association with a prior customer and their contact information, and automatically send an text or email notification to that customer to prompt them for payment once they arrive. This could ensure more payments are received rather than prior art physical kiosks along with less chance of a user not paying.
Tracking Post-Parking for Session Management: Upon payment, system 5 can begin tracking the location of consumer 80, especially if they continue to grant location access. Even without continuous location access, if consumer 80 uses discounts, coupons, or offers at local businesses 40 through the ad network, the system 5 can ping those business locations to estimate their position based on purchase timestamps. System 5 can analyze the user's movement, including traveling speed, to determine if they are driving (high speed) and when they slow down and stop for a certain period, assuming they are parking.
Automatic Session Management with Location Data: If consumer 80 authorizes continuous location tracking, the system 5 can start an open-ended parking session when they enter the parking zone, similar to a parking location. System 5 can track their movements around the area, gathering data for the ad network (e.g., shopping patterns). When consumer 80 returns to the parking zone, gets in their car 35, and drives away (detected by speed exceeding a threshold, indicating driving), system 5 can automatically end the parking session.
Session Extension Prompts: During tracking, if consumer 80 is traveling too far from their car 35 such that they would not return in time before the session expires, system can notify them to extend their session. System 5 can prompt them to verify additional purchases at local businesses through the ad network, potentially extending their session slightly based on the purchase amount.
Violation Prediction and Enforcement: Using location and shopping data, system 5 can predict if consumer 80 is likely to violate parking rules. For example, if their session is expired and they are too far away to return in time, based on their current location and the time remaining. If consumer 80 has entered the parking location geofence, and the system knows they were driving (via speed) and then walked to shop at local businesses 40 (via location and shopping data from the parking/advertising server 10), it can notify parking attendants of high-likelihood violators. Attendants can then enforce tickets or violations, improving enforcement efficiency compared to traditional methods like LPR technology.

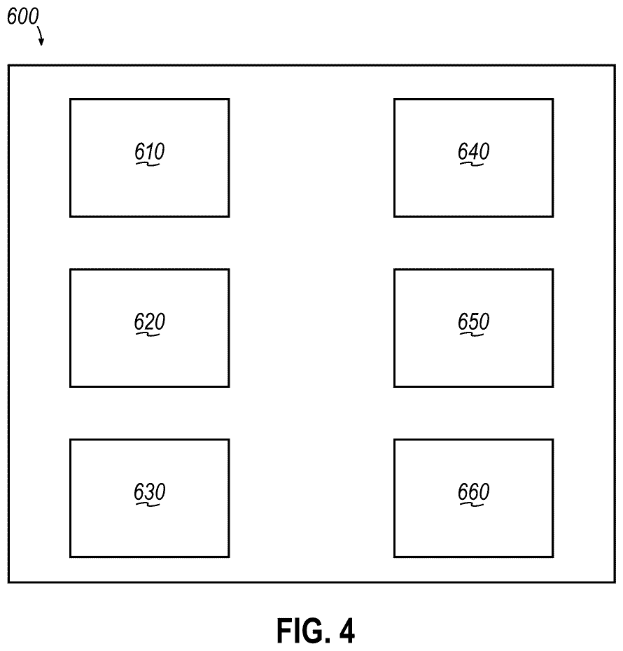

The preceding use case can be implemented as a system, e.g., parking/advertising server(s) 10. FIG. 4 illustrates one possible embodiments of parking/advertising server(s) 10. Server 600 can include geofencing module 610 to detect entry into parking areas and track user location. Notification module 620 can be used to prompt users to pay for parking and extend sessions. Speed analysis module 630 can be used to determine driving status and manage session start/end. Session management module 640 can be used to handle extensions and automatic ending. Violation prediction module 650 can be for using location and shopping data from the ad network. Enforcement notification module 660 can be used to alert parking attendants.

### Location-Based Ad Delivery at Entry Points

There are additional location-based functionalities under the present disclosure, such as location-based advertisement delivery at entry points. This can include delivering targeted advertisements to consumer 80 upon entering specific locations using various entry methods, such as NFC, QR codes, key cards, or ticket scans. Certain aspects and functionalities of such embodiments can be as follows:
Entry Detection and Data Collection: System 5 can detect when consumer 80 enters a location using a specific entry method, such as scanning a QR code to enter an apartment building, using NFC to access an office, or scanning a ticket for a concert. Each entry method provides precise location data and may include associated user data, such as previous transactions, preferences, or profiles stored in the system.
Ad Delivery Triggered by Entry: Upon detecting the entry, system 5 can trigger the delivery of targeted advertisements through a unified platform or application, such as a mobile app associated with the entry system. The advertisements can be selected based on the location of consumer 80 (e.g., apartment building for local services, event venue for merchandise) and their associated data (e.g., shopping history, preferences).
Integration with POS Systems for Rewards: System 5 can connect to POS systems of local businesses 40 or event vendors, allowing users to redeem discounts, coupons, or loyalty rewards based on the advertisements. Purchase data from POS systems can be fed back into system 5 to refine user profiles and improve future ad targeting.
Examples of Entry Points:
   i. Apartment Buildings: Users enter using NFC, QR codes, or key cards, triggering ads for nearby restaurants, cleaning services, or building-specific announcements.
   ii. Office Buildings: Similar entry methods trigger ads for office supplies, lunch options, or coworking space promotions.
   iii. Hotels: Check-in processes (e.g., QR code scan) trigger ads for hotel amenities, local attractions, or dining options.
   iv. Events (Concerts, Sports, etc.): Ticket scans trigger ads for merchandise, food vendors, or related events, enhancing the user experience.
User Behavior Tracking and Refinement: System 5 can track repeated entries or patterns (e.g., daily office entry, weekly event attendance) to refine ad targeting over time. If consumers 80 grant continuous location access, the system 5 can monitor their activities within the location to deliver more context-specific ads.

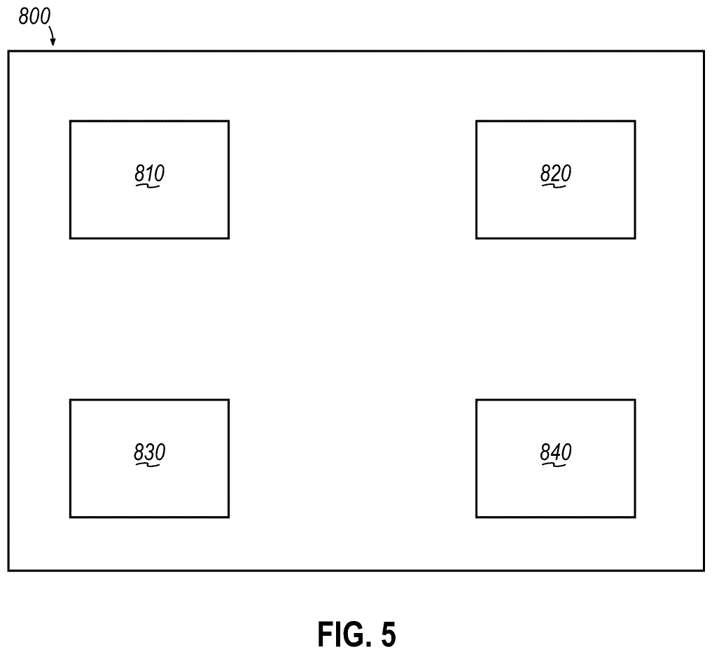

The preceding use case can be implemented as a system, e.g., parking/advertising server(s) 10. FIG. 5 illustrates one possible embodiments of parking/advertising server(s) 10. Server 800 can include one or more entry detection modules 810, each configured for different entry methods (e.g., NFC module, QR code scanner, ticket scanner). A data aggregation and analysis module 820 to build and refine user profiles across entry points. Advertisement selection and delivery module 830 can be used to choose and deliver context-specific ads. POS integration module 840 can be used to manage reward redemption and update user data.

### Advertisement Delivery via Location-Based Financial Transactions

There are other location-based embodiments and functionalities under the present disclosure. For example, some embodiments can include advertisement delivery via location-based financial transactions. Such embodiments can involve methods and systems for delivering targeted advertisements to consumers 80 during or after location-based financial transactions in e.g. metropolitan areas, using data from diverse urban mobility and payment services. Embodiments can include e.g.:
Data Collection from Multiple Transaction Types:
   i. Electric Scooters (e.g., Lime, Bird): Capture trip start/end locations, duration, and user profile data (if available) when users rent scooters via apps.
   ii. City Bikes (e.g., Citi Bike): Collect payment data, station locations, and trip details from bike-sharing programs.
   iii. Ride-Sharing Services (e.g., Uber, Lyft, Waymo): Gather pickup/drop-off locations, routes, and user preferences from ride bookings.
   iv. Digital Payment Systems (e.g., Apple Pay, Google Pay, Square, Shopify): Obtain transaction data, including merchant details, purchase amounts, and location (where available) from mobile or POS payments.
   v. Data can be aggregated into a unified platform, ensuring compliance with privacy regulations like GDPR (General Data Protection Regulation), CCPA (California Consumer Privacy Act), VCDPA (Virginia), CPA (Colorado Privacy Act), and/or other state or national data privacy laws.
Consumer Profile Development: Build detailed profiles using:
   i. Location History: Patterns may be tracked/stored from various sources, such as: scooter trips, bike rentals, smart device 85 location services, foot traffic, parking locations 50, ride-sharing destinations, and/or other location tracking systems.
   ii. Transaction Behavior: Purchase types, amounts, and merchant categories from digital payments.
   iii. Preferences: Inferred from repeated activities (e.g., frequent coffee shop visits).
   iv. Use machine learning to analyze data and update profiles in real-time, including using AI/ML for consumer data enhancement or refinement from third party data sources.
Proximity-Based Ad Delivery:
   i. Trigger ads when users complete transactions, such as:
      1. Finishing a scooter ride near a retail store.
      2. Paying for a bike rental at a station.
      3. Arriving at a ride-sharing drop-off point.
      4. Making a digital payment at a local business.
      5. Upon parking by consumer 80
      6. Upon a location-based trigger related to consumer 80, such as location service when walking.
   ii. Select ads based on:
      1. Current location (e.g., within 500 meters of a business).
      2. Recent transaction context (e.g., just paid for a ride).
      3. Consumer profile (e.g., prefers dining out).
   iii. Deliver ads via:
      1. In-app notifications within partner apps (e.g., Lime, Uber).
      2. Push notifications or SMS/email campaigns.
      3. Integration with your ad network's mobile app.
Partnerships and Revenue Sharing:
   i. Establish data-sharing agreements with service providers (e.g., Lime, Uber, Apple Pay) to access transaction and location data.
   ii. Deliver ads through their user interfaces (e.g., post-trip screens in ride-sharing apps).
   iii. Share ad revenue with partners, incentivizing participation and creating a scalable ecosystem.
Examples of Ad Scenarios:
   i. Scooter User: A user ends a Lime scooter ride near a shopping district and receives an advertisement for a nearby clothing store discount.
   ii. City Bike User: After returning a Citi Bike, a user gets a push notification for a café deal at the station's vicinity.
   iii. Ride-Sharing Passenger: A Lyft user arriving at a downtown drop-off sees an in-app advertisement for a local event.
   iv. Digital Payment Customer: A user paying with Apple Pay at a bookstore receives an SMS advertisement for a nearby stationery shop.
   v. Parking: Customer 80 parking at parking location 50 may receive an advertisement for a nearby stores 80.

Certain methods can include the following steps:
Detecting transaction events, e.g., identifying when consumer 80 completes a location-based financial transaction, such as renting an electric scooter, paying for a city bike, booking a ride-sharing trip, or making a digital payment, via a unified platform or partner apps.
Collecting and aggregating data, e.g, gathering location data (e.g., trip start/end, payment location), transaction details (e.g., amount, merchant), and user data (e.g., profile, preferences) from these transactions; and/or aggregating data

from multiple sources into a centralized system, ensuring privacy compliance.
Building consumer profiles, e.g., analyzing aggregated data to create and update consumer profiles, incorporating location history, transaction behavior, and inferred preferences using machine learning.
Selecting and delivering advertisements, e.g., selecting advertisements based on the user's current location, recent transaction context, and profile; and delivering ads through partner apps, push notifications, SMS, or the ad network's platform, ensuring timely and relevant delivery.
Integrating with POS systems, e.g., connecting to POS systems of local businesses or vendors to automate reward redemption (e.g., discounts, coupons) based on ad interactions; and feeding purchase data back into the system to refine profiles.
Facilitating partnerships, e.g., establishing data-sharing agreements with service providers to access transaction data, and delivering ads through their user interfaces and share resulting ad revenue.

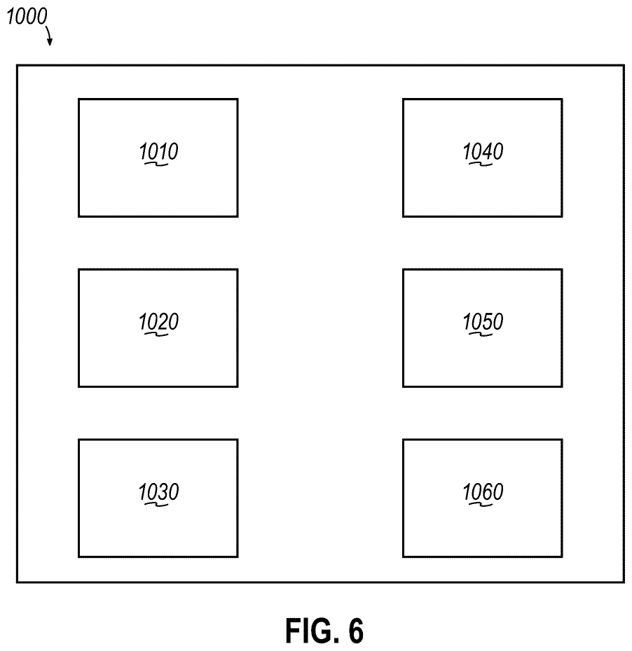

The preceding use case can be implemented as a system, e.g., parking/advertising server(s) 10. FIG. 6 illustrates one possible embodiments of parking/advertising server(s) 10. Server 1000 can comprise one or more transaction detection modules 1010, configured for scooters, bikes, ride-sharing, and payments. Data aggregation module 1020 can be used to normalize and store multi-source data. Profile analysis module 1030 can be used to build and update consumer profiles. Advertisement delivery module 1040 can be used to select and serve context-specific advertisements. POS integration module 1050 can manage reward redemption and data feedback. Partnership module 1060 can handle data access and revenue sharing with providers.

### Advertisement Delivery via Location-Based Financial Transactions

Another possible use case can include advertisement delivery via location-based financial transactions. In some embodiments this can include methods and systems for delivering targeted advertisements to users during or after location-based financial transactions in e.g., metropolitan areas, leveraging diverse urban mobility and payment data. Certain enhancements can include the integration of parking-specific data buildout features.

One aspect of such embodiments can include data collection from multiple transaction types. These can include, for example:
Parking Transactions (e.g., ParkPay): Collect parking event data, including license plates, vehicle details, payment information, and precise location and time of parking. This data acts as a deterministic indicator of a consumer's physical presence at a specific point-of-interest.
Electric Scooters (e.g., Lime, Bird): Capture trip start/end locations, duration, and consumer 80 profile data (if available) from app-based rentals.
City Bikes (e.g., Citi Bike): Collect payment data, station locations, and trip details from bike-sharing programs.
Ride-Sharing Services (e.g., Uber, Lyft, Waymo): Gather pickup/drop-off locations, routes, and user preferences from ride bookings.
Digital Payment Systems (e.g., Apple Pay, Google Pay, Square, Shopify): Obtain transaction data, including merchant details, purchase amounts, and location (where available) from mobile or POS payments. Collected data can be aggregated into a unified platform, ensuring compliance with privacy regulations like GDPR and CCPA.

Other aspects can include consumer profile development. In this regard, detailed profiles can be built using, e.g.:
Location History: Patterns from parking locations, scooter trips, bike rentals, and ride-sharing destinations.
Transaction Behavior: Purchase types, amounts, and merchant categories from digital payments and parking fees.
Preferences: Inferred from repeated activities (e.g., frequent parking at malls, regular coffee shop visits).
   Machine learning can be used to analyze data and update profiles in real-time. Embodiments can also include parking data integration for profile enrichment. Parking transaction data can provide deterministic identifiers (e.g., license plates, payment tokens) linkable to consumer 80 identities via enrichment processes (e.g., third-party APIs or DMV linkage). By deriving home addresses, the system 5 can create a robust identity graph, linking offline parking behavior to online profiles for precise ad targeting.

Embodiments can include proximity-based advertisement delivery. Trigger of advertisements in real-time can be based upon transaction completion, such as:
Parking at a Specific Location: Deliver ads for nearby businesses immediately after a parking event, using precise location and timing.
Finishing a scooter ride near a retail store.
Paying for a bike rental at a station.
Arriving at a ride-sharing drop-off point.
Making a digital payment at a local business. Selection of advertisements can be based on:
Current location (e.g., within 500 meters of a business).
Recent transaction context (e.g., just parked or paid for a ride).
Consumer profile (e.g., prefers dining out, inferred from parking patterns). Delivery of advertisements can be via, e.g.:
In-app notifications within partner apps (e.g., Lime, Uber, ParkPay).
Push notifications, SMS, or email campaigns.
Integration with an ad network's mobile app. In addition, embodiments can include programmatic integration. This may include integration with programmatic advertising platforms (e.g., Google DV360, The Trade Desk) to deliver advertisements across external inventory, using parking-derived audience segments to improve targeting accuracy and reduce waste.

Embodiments can include partnerships and revenue sharing. This may include, e.g.:
Establishing data-sharing agreements with service providers (e.g., Lime, Uber, ParkPay) to access transaction and location data.
Delivering advertisements through partner interfaces (e.g., post-trip screens in ride-sharing apps).
Sharing advertisement revenue with partners to incentivize participation and scale the ecosystem.

Examples of advertisement scenarios can include the following:
Parking User: Consumer 80 parks near a shopping district and receives an advertisement for a nearby clothing store discount.
Scooter User: Consumer 80 ends a Lime ride near a café and gets an in-app advertisement for a coffee deal.
City Bike User: After returning a Citi Bike, consumer 80 receives a push notification for a local event.
Ride-Sharing Passenger: A Lyft consumer 80 arriving downtown sees an advertisement for a nearby restaurant.
Digital Payment Customer: Consumer 80 paying with Apple Pay at a bookstore gets an SMS advertisement for a stationery shop.

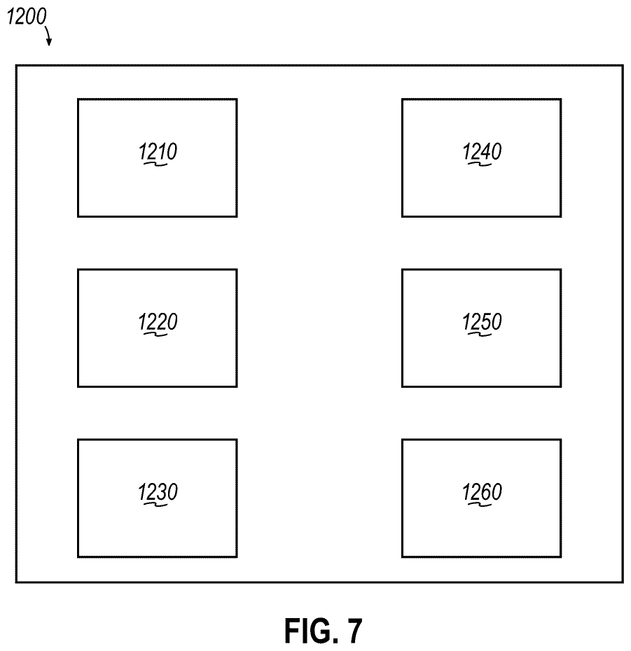

The preceding use case can be implemented as a system, e.g., parking/advertising server(s) 10. FIG. 7 illustrates one possible embodiment of parking/advertising server(s) 10. Server 1200 can comprise one or more transaction detection modules 1210 for integrating with third parties for parking, scooters, bikes, ride-sharing, and payments. Data aggregation module 1220 can be used to normalize multi-source data, including parking events. Profile analysis module 1230 can create/update profiles with parking and transaction data. Ad delivery module 1240 can serve context-specific advertisements, triggered by parking and other transactions. POS integration module 1250 can manage rewards and data feedback. Partnership module 1260 can handle data and revenue sharing.

### Mobile Wallet Use Cases

Further use cases can include mobile wallet systems and methods for parking management, loyalty rewards, and targeted advertising. Embodiments can utilize a mobile wallet pass (e.g., Apple Wallet or Google Wallet) to manage parking location access, process payments, handle permits, deliver proximity-based advertisements, and automate coupon and loyalty reward redemption, and/or perform or assist in other tasks. System 5 can integrate existing mobile wallet technologies with parking infrastructure, loyalty programs, and advertising networks to provide a seamless user experience.

Mobile wallet technologies, such as Apple Wallet and Google Wallet, are widely used for storing passes like boarding passes, loyalty cards, and coupons. System 5 can leverage NFC and QR codes for various applications, including parking access and payment, to provide a single system that fully integrates parking access, permit management, proximity-based ads, and automated reward redemption. Aspects can include:
Parking Access and Payment
   i. Functionality: Consumer 80 can store a parking pass in their mobile wallet, using NFC or QR codes to enter and exit parking locations.
   ii. Process: On entry, the pass communicates with the NFC/QR code reader (smart devices 55) of parking location 50 to start a parking session linked to the account of consumer 80. On exit, the system 5 or smart devices 55 end the session, calculates fees, and processes payments automatically via the linked payment method.
Permit Management
   i. Functionality: For consumers 80 that are permit holders, system 5 can automatically associates the permit with the parking location.
   ii. Process: The pass validates the permit via the wallet's secure element, granting seamless access without additional steps.
Proximity-Based Advertising
   i. Functionality: Parking actions (entry/exit) trigger targeted advertisements based on the location of consumer 80.
   ii. Process: Geofencing around the parking location or location data (with consumer 80 consent) identifies nearby businesses 40. Advertisements can be delivered via push notifications or within the wallet pass.
Coupons, Discounts, and Loyalty Rewards
   i. Functionality: The wallet pass stores coupons, discounts, and loyalty rewards linked to the proximity parking account of consumer 80.
   ii. Process: Consumer 80 can save offers to their pass and receive notifications when near participating businesses 40. At point of sale at businesses 40, NFC or QR code scanning redeems offers and applies rewards automatically.
Backend Automation
   i. Functionality: Tracks advertisement conversions and reward redemptions automatically.
   ii. Process: Integrates with parking/advertisement server(s) 10, and/or third party servers 12, and point of sale systems to monitor advertisement views, purchases, and redemptions. System 5 can thereby automate reward application and conversion tracking, reducing manual intervention.

The preceding embodiments and features can involve one or more of the following functionalities. Integrated functionality - the embodiment combines parking access, payment, permit management, loyalty rewards, and targeted advertisements into a single mobile wallet pass. Proximity-based advertisement triggers: the embodiments uses parking actions as a unique trigger for delivering location-specific advertisements, enhancing relevance. Automated backend processes: the embodiment streamlines advertisement conversion tracking and reward redemption, improving efficiency. Seamless user experience: the embodiment provides a unified interface for multiple services, reducing complexity for consumers 80.

Technical implementation can comprise mobile wallet integration, for any of a variety of digital/mobile wallets. For example, APIs for Apple Wallet and/or Google Wallet can be used to manage passes. Further aspects of technical implementation can make use of NFC/QR code readers, which can be installed as compatible readers at parking location entry/exit points. Backend systems can comprised centralized (or dispersed/remote) servers (such as parking/advertisement server(s) 10, and/or third party servers 12) for parking session management, payment processing, and permit validation. Integration with loyalty platforms and advertisement networks for reward tracking and advertisement delivery can be via e.g., third party servers 12. Location APIs can be used for geofencing, ensuring compliance with privacy regulations (e.g., GDPR, CCPA). Regarding privacy, it may be necessary to obtain user consent for location data and advertisement targeting, adhering to legal standards.

### AI/ML Embodiments

Various embodiments under the present disclosure can incorporate AI/ML (artificial intelligence or machine learning) functionality. For example, for purposes of the present disclosure, parking/advertising server 10 can carry out AI/ML functionality. For example, as described above parking/advertising server 10 may collect a variety of data regarding parking locations 50, consumers 80, smart devices 85, stores 40, computing devices 45, 55, or other variables in system 5 and other systems and methods described herein. One use of such data may be to use AI/ML functionality to improve marketing material 220.

For example, data collected could include e.g.: size of advertisement, coupon discount amounts, customer background or purchasing data, purchase amounts, store 40 identification, marketing data from third parties such as Google Ads, Facebook, X, etc., and a variety of other data. This data can be used to analyze what types of content, store type, or other variables generate the most income, or other types of metrics. This data can also be used to train AI/ML models, or can be analyzed by a previously trained AI/ML model.

The term artificial intelligence commonly refers to an entire system that achieves intelligence-like outcomes while using multiple sub-systems, such as multiple machine learning algorithms. But both ML and AI have been used to identify a variety of functionalities or types of systems that utilize various combinations of specific ML algorithms. As used herein, AI/ML may be intended to denote a variety of AI/ML functionalities that fall under the category of AI or ML algorithms and systems that utilize such functionalities. Examples of AI/ML can comprise any one or more of e.g.: supervised learning, reinforcement learning, natural language processing such as LLMs, neural networks, computer vision, facial recognition, chatbots, virtual assistants, unsupervised learning, generative AI, other AI or ML models, and/or combinations of any of the foregoing. Data used to train, retrain, or implement any of AI/ML functionalities described may be stored at any one or more of the components shown in FIG. 1. A person of ordinary skill in the art may recognize that a variety of such variations are possible under the present disclosure.

The architecture of an AI/ML model (e.g., structure, number of layers, nodes per layer, activation function etc.) may need to be tailored for each particular use case. For example, properties to vary can include e.g.: consumer characteristic (race, sex, age, etc.), store identification, advertisement type, coupon amounts, and a variety of other factors. These may all need to be considered when designing an AI/ML model architecture.

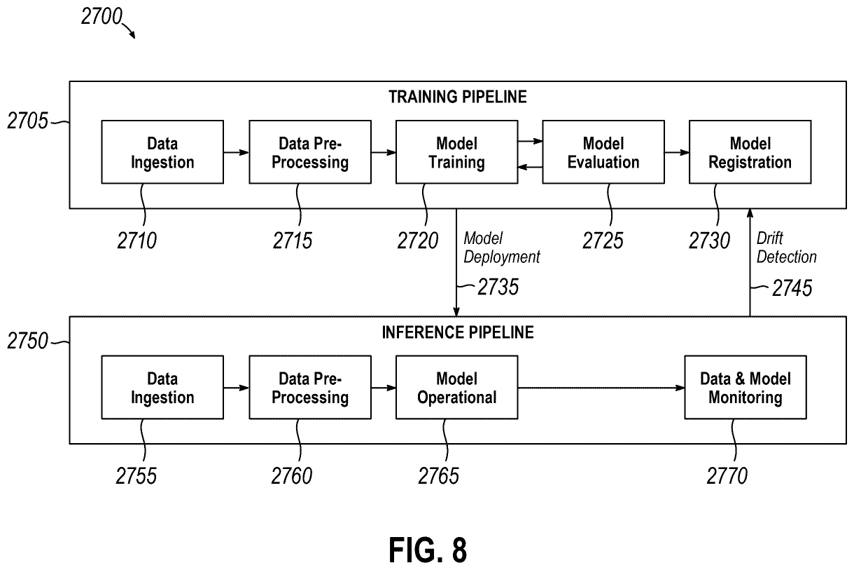

Building an AI/ML model can include several development steps where the actual training of a ML model or algorithm may be just one step in a training pipeline. An important part in AI/ML development may be AI/ML model lifecycle management. One embodiment of a model lifecycle management procedure 2700 is illustrated in FIG. 8. In one or more embodiments, model lifecycle management procedure 2700 can in some embodiments comprise two pipelines: a training pipeline 2705 and an inference pipeline 2750.

At 2710 in training pipeline 2705, data ingestion 2710 occurs, which includes gathering raw (training) data from a data storage. After data ingestion 2710, there may also be a step that controls the validity of the gathered data. At 2715, data pre-processing occurs, which can include feature engineering applied to the gathered data. This may involve, e.g., data normalization or data formatting or transformation required for the input data to the AI/ML model. After the ML model's architecture is fixed, it can be trained on one or more datasets. At 2720, model training may be performed in which the AI/ML model may be trained with the raw training data. To achieve good performance during live operation in a system (the so-called inference phase), the training datasets should be representative of actual data the ML model may encounter during live operation. The training process often involves numerically tuning the ML model's trainable parameters (e.g., the weights and biases of the underlying neural network (NN)) to minimize a loss function on the training datasets. The loss function may be, for example, based on a maximizing sales to stores 40 of FIG. 1; minimizing marketing costs; maximizing parking use by consumers 80; or other metrics. The purpose of the loss function is to meaningfully quantify the reconstruction error for the particular use case at hand. At 2725, model evaluation can be performed where the performance may be benchmarked to some baseline. Model training 2720 and evaluation 2725 can be iterated until an acceptable level of performance may be achieved. At 2730, model registration occurs, in which the AI/ML model may be registered with any corresponding data on how the AI/ML model was developed, and e.g., AI/ML model evaluation data. At 2735, model deployment occurs, wherein the trained/re-trained AI/ML model may be implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 may be used to process new data received during operation of e.g., system 5 of FIG. 1 or components thereof. At 2770, data and model monitoring may be performed. Here the inference data may be analyzed to determine whether the inference data are from a distribution that aligns with the training data, as well as monitoring model outputs for detecting any performance, or operational, variance or drifts. The variance or drift may be used at 2745 (drift detection) to update the AI/ML model registration.

In certain embodiments, drift detection can be implemented using a two-layer monitoring mechanism e.g.: (1) a real-time anomaly detection module that can flag deviations in incoming data distributions based on statistical metrics such as KL divergence or Wasserstein distance, and (2) a feedback loop that can evaluate the performance of predictions using ground-truth outcomes collected periodically from consumer interactions (e.g., parking selections, transaction completions, or marketing click-through rates). When drift is detected, the system can employ a staged response mechanism. First, the anomaly detection module can trigger an adaptive model retraining process, leveraging transfer learning to update weights without requiring full model re-training. Second, a shadow deployment strategy can be employed, where updated models can be tested alongside live models to assess performance improvements before replacing the production model. Certain embodiments can minimize operational downtime and ensure the model adapts effectively to changing consumer behavior patterns, such as shifts in parking preferences during seasonal changes or varying marketing material responsiveness over time.

The training process may typically be based on some variant of a gradient descent algorithm, which typically comprises three components: a feedforward step, a back propagation step, and a parameter optimization step. These steps can be described using a dense ML model (i.e., a dense NN with a bottleneck layer) as an example.

Feedforward: A batch of training data, such as a mini-batch, (e.g., several downlink-channel estimates) may be pushed through the ML model, from the input to the output. The loss function may be used to compute the reconstruction loss for all training samples in the batch. The reconstruction loss may be an average reconstruction loss for all training samples in the batch.

Back propagation (BP): The gradients (partial derivatives of the loss function, L, with respect to each trainable parameter in the ML model) may be computed. The back propagation algorithm sequentially works backwards from the ML model output, layer-by-layer, back through the ML model to the input. The back propagation algorithm may be built around the chain rule for differentiation: When computing the gradients for layer n in the ML model, it may use the gradients for layer n+1.

Parameter optimization: The gradients computed in the back propagation step may be used to update the ML model's trainable parameters. An approach may be to use the gradient descent method with a learning rate hyperparameter (α) that scales the gradients of the weights and biases. It may be preferred to make small adjustments to each parameter with the aim of reducing the average loss over the (mini) batch. It may be common to use special optimizers to update the ML model's trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) can be repeated many times until an acceptable level of performance may be achieved on the training dataset. An acceptable level of performance may refer to the ML model achieving a pre-defined average reconstruction error over the training dataset (e.g., normalized MSE of the reconstruction error over the training dataset may be less than, say, 0.1). Alternatively, it may refer to the ML model achieving a pre-defined value chosen by a user.

In some implementations, a function F(⋅) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware (e.g., parking/advertising server 10) described in system 5 of FIG. 1 (e.g., in the form of simple vector-matrix multiplications).

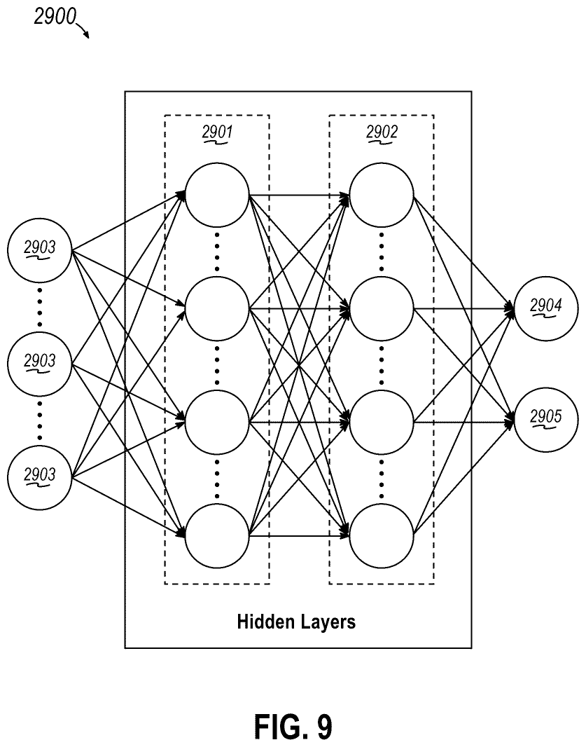

Referring now to FIG. 9, an example NN 2900 (e.g., DNN) is shown. In some implementations, and as shown, the neural network 2900 may include two hidden layers represented by dashed boxes 2901 and 2902. In one implementation, the inputs 2903 may be fed into the NN 2900. Next, the inputs 2403 may go through a set of hidden layers (e.g., 2901 and/or 2902). Once the inputs 2903 pass though the hidden layers 2901 and/or 2902, they may be output (e.g., as an output layer) as outputs 2904, 2905. Outputs 2904, 2905 could be, e.g., customer 80 spend at stores 40, advertiser spend on content, parking spaces used; or another output valuable. Possible inputs can include e.g.: consumer 80 identification data (e.g., age, income, home city, etc.), store 40 identification, or other variables.

As should be understood by one of ordinary skill in the art, in order for the NN 2900 to output proper a proper analysis, it should be trained properly (e.g., with a collection of samples) to accurately extract the likelihood values. If not trained properly, overfitting (e.g., when the NN memorizes the structure of the preambles but may be unable to generalize to unseen preamble characteristics) or underfitting (e.g., when the NN may be unable to learn a proper function even on the data that it was trained on) may happen. Thus, implementations may exist that prevent overfitting or underfitting, involving a set of well-engineered features that must be extracted from the preamble characteristics.

Certain embodiments can employ a custom hybrid neural network architecture tailored for optimizing parking and advertising outcomes in real-time. This architecture can integrate a convolutional neural network (CNN) layer for spatial data processing (e.g., analyzing parking lot layouts or heatmaps of available spaces) with a recurrent neural network (RNN) module, specifically a gated recurrent unit (GRU), for sequential data processing (e.g., historical consumer movement patterns or time-series trends in parking occupancy).

To enhance predictive accuracy, certain embodiments of utilized ML models can incorporate an attention mechanism within the RNN module. This mechanism can assign dynamic weights to past consumer interactions, such as parking spot preferences or response rates to specific marketing offers, ensuring the model prioritizes the most relevant historical data.

Certain embodiments of a training pipeline under the present disclosure can introduce a domain-specific feature engineering layer that transforms raw input data, such as consumer demographics and transaction logs, into high-dimensional embeddings optimized for the hybrid architecture. A novel loss function can be employed, which may combine traditional prediction accuracy with domain-specific metrics like parking space turnover and advertising click-through rates.

During deployment, certain embodiments can utilize federated learning to enable continuous model updates while preserving consumer data privacy. Such approaches may ensure the model evolves dynamically as new data is collected from distributed parking locations and advertising platforms.

### Additional Embodiments

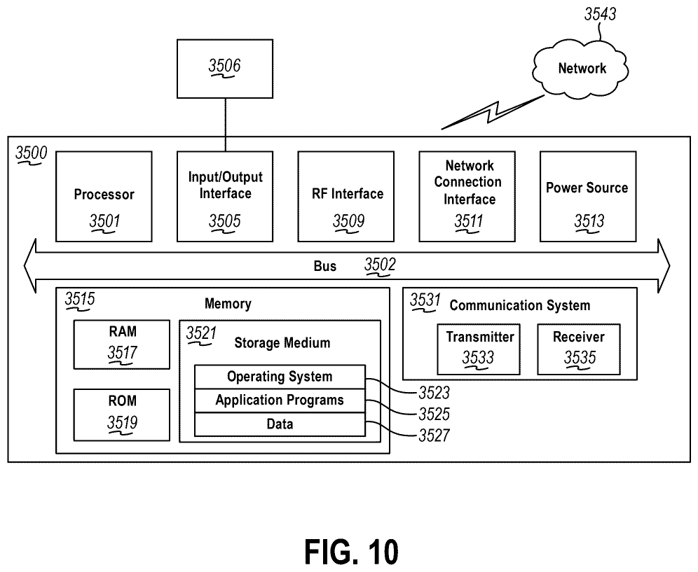

FIG. 10 illustrates an embodiment of various computing devices 3500 within system 5 of FIG. 1, or components thereof e.g., computing devices 45, 55, parking/advertising server(s) 10, and/or smart device 85, which can comprise e.g., computers, tablets, servers, databases, mobile devices, or other computing or smart devices. FIG. 5 shows a schematic block diagram of a computing device 3500 (or components thereof) according to certain embodiments of the present disclosure. Computing device 3500 can be used to analyze and/or optimize: the functionalities described with respect to e.g., computing devices 45, 55, parking/advertising server(s) 10, and/or smart device 85, or to perform other methods, such as AI or ML-related tasks and analyses as described herein.

Computing device 3500 includes processor 3501 that may be operatively coupled via a bus 3502 to an input/output interface 3505, a power source 3513, a memory 3515, a RF interface 3509, network communication interface 3511, and/or any other component, or any combination thereof. The level of integration between the components may vary from one embodiment to another. Further, certain computing devices 3500 (or components thereof) may contain multiple instances of a component, such as multiple processors, memories, transceivers, transmitters, receivers, etc.

The processor 3501 may be configured to process instructions and data and may be configured to implement any sequential state machine operative to execute instructions stored as machine-readable computer programs in memory 3515. Processor 3501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 3501 may include multiple central processing units (CPUs).

In the example, input/output interface 3505 may be configured to provide an interface or interfaces to an input/output device(s) 3506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 3500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 3513 may be structured as a battery or battery pack. Other types of power sources, such as an external power source (e.g., an electricity outlet), photovoltaic device, or power cell, may be used. The power source 3513 may further include power circuitry for delivering power from the power source 3513 itself, and/or an external power source, to the various parts of computing device 3500 via input circuitry or an interface such as an electrical power cable.

Memory 3515 may be configured to include memory such as random-access memory (RAM) 3517, read-only memory (ROM) 3519, programmable read-only memory (PROM), erasable programmable read-only memory (EPROM), electrically erasable programmable read-only memory (EEPROM), magnetic disks, optical disks, hard disks, removable cartridges, flash drives, other storage medium 3521, and so forth. In one example, the memory 3515 includes one or more application programs 3525, an operating system 3523, web browser application, a widget, gadget engine, or other application, and corresponding data 3527. Memory 3515 may store, for use by the computing device 3500, any of a variety of various operating systems or combinations of operating systems. An article of manufacture, such as one including a simulation system or communication system may be tangibly embodied as or in memory 2515, which may be or comprise a device-readable storage medium.

Processor 3501 may be configured to communicate with an access network or other network using the RF interface 3509 or network connection interface 3511. The RF interface 3509 or network connection interface 3511 may comprise one or more communication subsystems and may include or be communicatively coupled to an antenna. In the illustrated embodiment, communication functions of the RF interface 3509 or network connection interface 3511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

System 5 of FIG. 1 (e.g., parking/advertising server 10), or computing devices 3500 as described above in regard to FIG. 10, can perform a variety of method embodiments under the present disclosure. Several example method embodiments are given below but these examples are non-limiting and are only meant to illustrate certain embodiments.

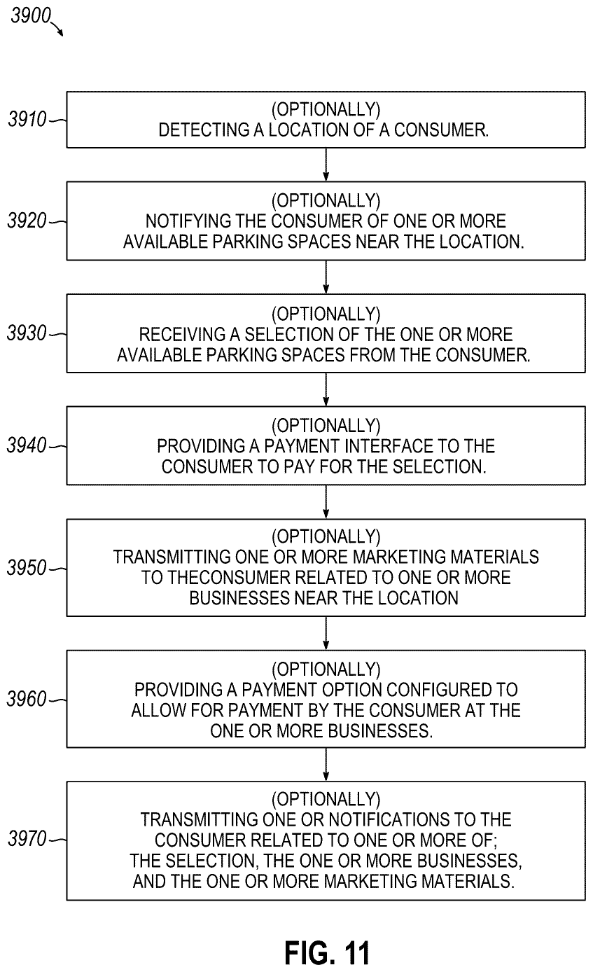

A possible method embodiment under the present disclosure is shown in FIG. 11. Method 3900 comprises a method performed by a parking and advertising system. Step 3910 may (optionally) be detecting a location of a consumer. Step 3920 may (optionally) be notifying the consumer of one or more available parking spaces near the location. Step 3930 may (optionally) be receiving a selection of the one or more available parking spaces from the consumer. Step 3940 may (optionally) be providing a payment interface to the consumer to pay for the selection. Step 3950 may (optionally) be transmitting one or more marketing materials to the consumer related to one or more businesses near the location. Step 3960 may (optionally) be providing a payment option configured to allow for payment by the consumer at the one or more businesses. Step 3970 may (optionally) be transmitting one or more notifications to the consumer related to one or more of; the selection, the one or more businesses, and the one or more marketing materials. Method 3900 can comprise a variety of additional, optional, or alternative steps or other variations. For example, some embodiments can further comprise transmitting, to the device, one or more payment options to allow for payment by the consumer at the one or more businesses. Some embodiments can further comprise using artificial intelligence or a machine learning model to analyze at least one of: the selection; the one or more businesses; the one or more marketing materials. Some variations can further comprise detecting or receiving a notification of a parking violation of the consumer. Some embodiments can further comprise transmitting, to the device, a notification to make a purchase at the one or more businesses to satisfy the parking violation. In some variations, the one or more marketing materials comprise at least one of: an advertisement for the one or more businesses; a coupon code for the one or more businesses; an option to make a purchase at the one or more businesses in lieu of paying for the parking space. Some embodiments can further comprise transmitting, to a digital wallet of the device, a record of the parking space. Some embodiments can further comprise: detecting or receiving a location of the consumer; calculating a travel time for the consumer to return to the parking space; and if the travel time is longer than a remaining parking time, transmitting to the device an option for the consumer to purchase more parking time. The steps of method 3900, and/or any optional or alternative steps, may be performed simultaneously or in parallel in certain embodiments.

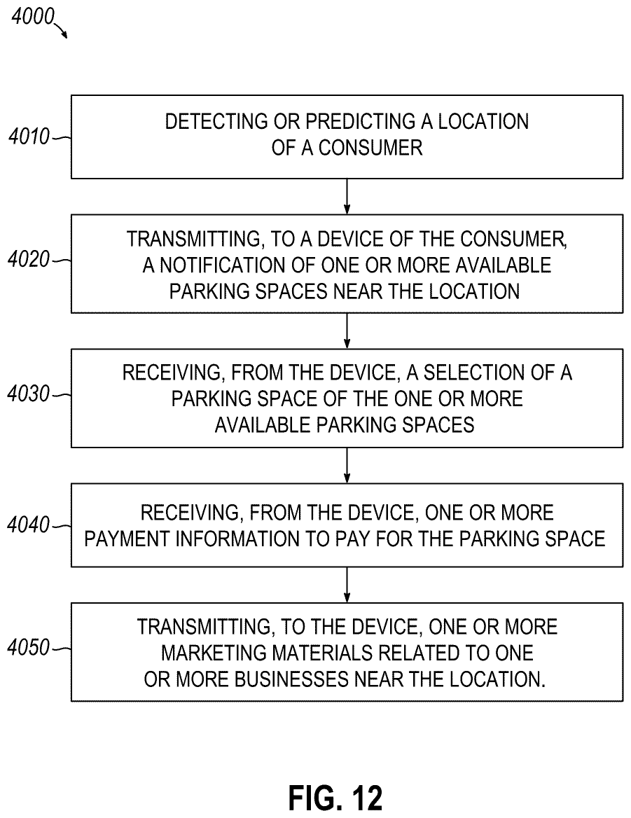

FIG. 12 illustrates another possible method under the present disclosure. FIG. 12 illustrates a method 4000 performed by a parking and advertising system. Step 4010 is detecting or predicting a location of a consumer. Step 4020 is transmitting, to a device of the consumer, a notification of one or more available parking spaces near the location. Step 4030 (which may be optional) is receiving, from the device, a selection of a parking space of the one or more available parking spaces. Step 4040 (which may be optional) is receiving, from the device, one or more payment information to pay for the parking space. Step 4050 (which may be optional) is transmitting, to the device, one or more marketing materials related to one or more businesses near the location. Method 4000 can comprise a variety of additional, optional, or alternative steps or other variations. For example, some embodiments can further comprise transmitting, to the device, one or more payment options to allow for payment by the consumer at the one or more businesses. Some embodiments can further comprise using artificial intelligence or a machine learning model to analyze at least one of: the selection; the one or more businesses; the one or more marketing materials. Some variations can further comprise detecting or receiving a notification of a parking violation of the consumer. Some embodiments can further comprise transmitting, to the device, a notification to make a purchase at the one or more businesses to satisfy the parking violation. Some embodiments can further comprise receiving, from a computing device, a new location of the consumer, wherein the computing device comprises at least one of: the device; a Wi-Fi router; a Bluetooth device; a near field communication device; a store payment kiosk. In some variations, the one or more marketing materials comprise at least one of: an advertisement for the one or more businesses; a coupon code for the one or more businesses; an option to make a purchase at the one or more businesses in lieu of paying for the parking space. Some embodiments can further comprise transmitting, to a digital wallet of the device, a record of the parking space. Some embodiments can further comprise: detecting or receiving a location of the consumer; calculating a travel time for the consumer to return to the parking space; and if the travel time is longer than a remaining parking time, transmitting to the device an option for the consumer to purchase more parking time. The steps of method 4000, and/or any optional or alternative steps, may be performed simultaneously or in parallel in certain embodiments.

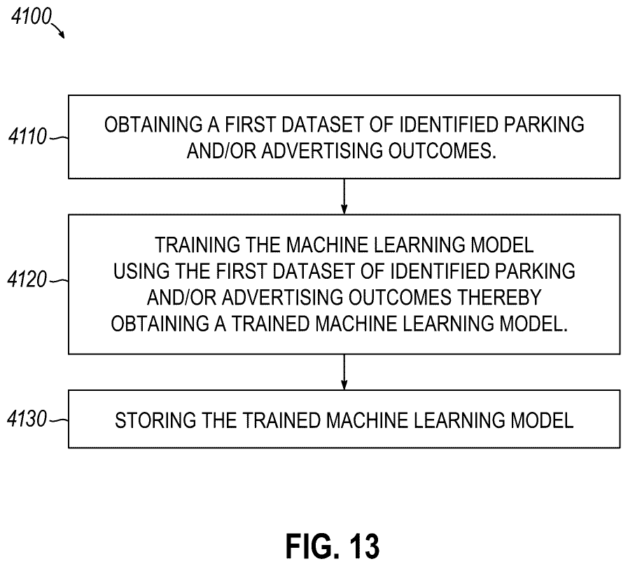

Another possible method embodiment under the present disclosure is shown in FIG. 13. Method 4100 may be a computer implemented method for training a machine learning model for optimizing parking and/or advertising to consumers. Step 4110 may be obtaining a first dataset of identified parking and/or advertising outcomes. Step 4120 may be training the machine learning model using the first dataset of identified parking and/or advertising outcomes thereby obtaining a trained machine learning model. Step 4130 may be storing the trained machine learning model. Method 4100 can comprise a variety of additional, optional, or alternative steps or other variations. For example, some embodiments can further comprise further training the trained machine learning model using a second dataset of identified parking and/or advertising outcomes, thereby obtaining a further trained machine learning model; and storing the further trained machine learning model. In some embodiments, the first dataset of identified parking and/or advertising outcomes and/or the second dataset of identified parking and/or advertising outcomes comprise one or more of: customer spend; advertiser spend; number of views by customers; time spent parking; parking spend. In some embodiments, the machine learning model uses one or more inputs comprising one or more of: business identification; marketing type or characteristic; consumer identification information; location of consumer; location of parking garage; time of day. The steps of method 4100, and/or any optional or alternative steps, may be performed simultaneously or in parallel in certain embodiments.

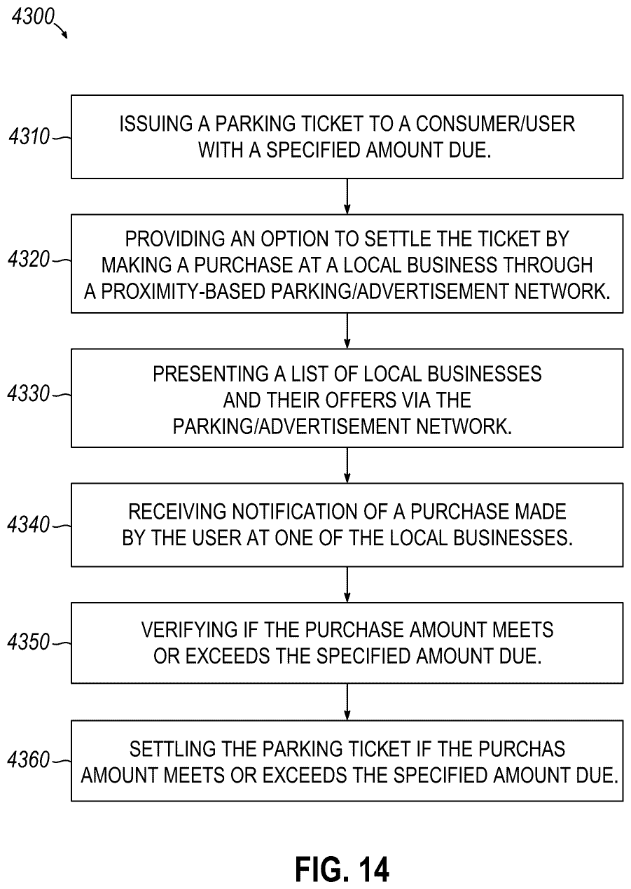

FIG. 14 illustrates another possible method embodiment under the present disclosure. Method 4300 comprises a method for settling a parking ticket. Step 4310 is issuing a parking ticket to a consumer/user with a specified amount due. Step 4320 is providing an option to settle the ticket by making a purchase at a local business through a proximity-based parking/advertisement network. Step 4330 is presenting a list of local businesses and their offers via the parking/advertisement network. Step 4340 is receiving notification of a purchase made by the user at one of the local businesses. Step 4350 is verifying if the purchase amount meets or exceeds the specified amount due. Step 4360 is settling the parking ticket if the purchase amount meets or exceeds the specified amount due. Method 4300 can comprise a variety of additional, optional, or alternative steps or other variations. For example, in some embodiments, the purchase is made online through a link provided by the parking/advertisement network, and the notification is received automatically upon completion of the purchase. In some embodiments, the purchase is made in person at a business with an integrated point of sale system, and the notification is received automatically from the point of sale system. In some embodiments, the purchase is made in person at a business without an integrated point of sale system, and the notification is received through user-submitted receipt verification.

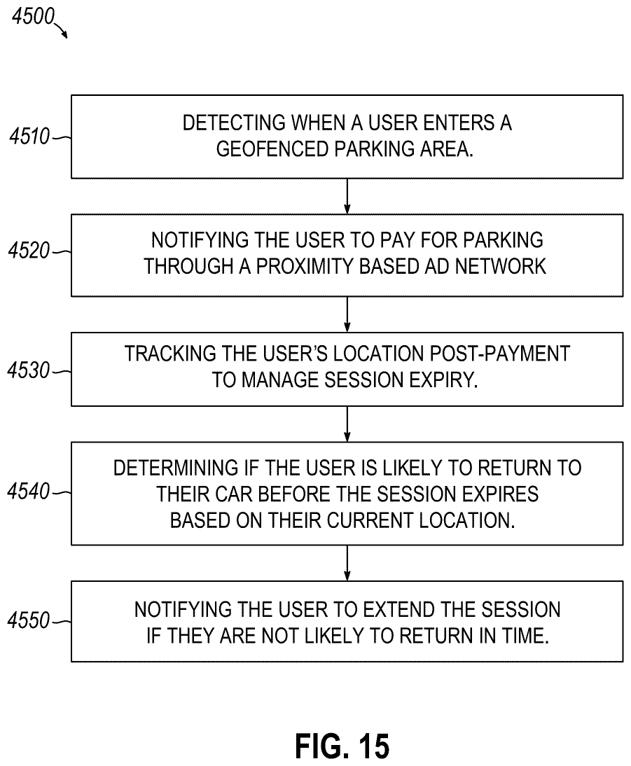

FIG. 15 illustrates another possible method embodiment under the present disclosure. Method 4500 comprises a method for managing parking sessions. Step 4510 is detecting when a user enters a geofenced parking area. Step 4520 is notifying the user to pay for parking through a proximity-based ad network platform. Step 4530 is tracking the user's location post-payment to manage session expiry. Step 4540 is determining if the user is likely to return to their car before the session expires based on their current location. Step 4550 is notifying the user to extend the session if they are not likely to return in time. Method 4500 can comprise a variety of additional, optional, or alternative steps or other variations. For example, some embodiments can further comprise starting the parking session when the user enters the parking zone and ends it when they drive away, determined by their speed exceeding a threshold. Some variations can further comprise: using shopping data from the parking/advertisement network to predict if the user is likely to violate parking rules; and notifying parking attendants to enforce tickets based on the prediction.

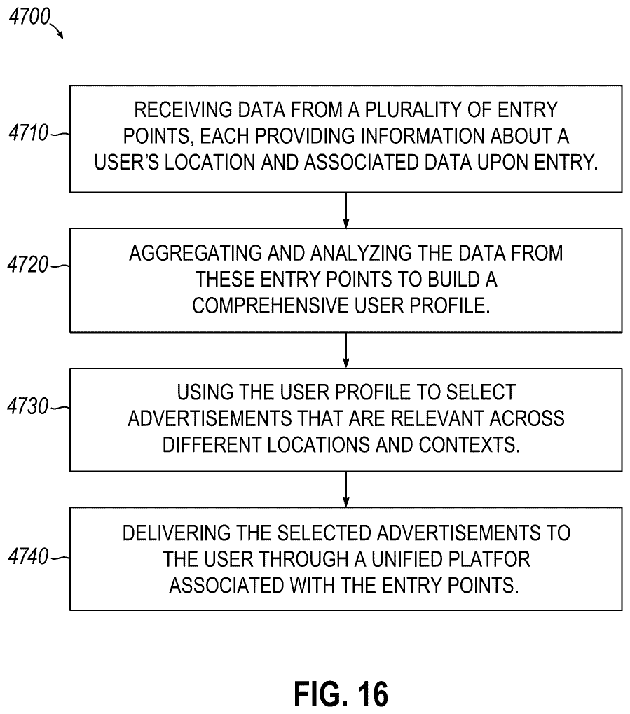

FIG. 16 illustrates another possible method embodiment under the present disclosure. Method 4700 comprises a method for delivering targeted advertisements to users across multiple location-based entry points. Step 4710 is receiving data from a plurality of entry points, each providing information about a user's location and associated data upon entry. Step 4720 is aggregating and analyzing the data from these entry points to build a comprehensive user profile. Step 4730 is using the user profile to select advertisements that are relevant across different locations and contexts. Step 4740 is delivering the selected advertisements to the user through a unified platform associated with the entry points. Method 4700 can comprise a variety of additional, optional, or alternative steps or other variations. For example, in some embodiments the entry points include parking payments, building entries via NFC or QR code, and event ticket scans. Some embodiments can further comprise connecting to point of sale (POS) systems of local businesses or event vendors; automating reward redemption based on the user's interaction with advertisements; and/or updating the user profile with purchase data from the POS systems.

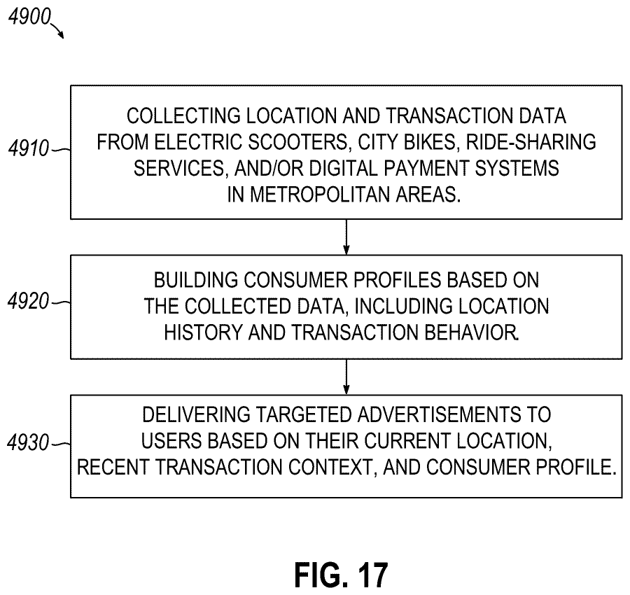

FIG. 17 illustrates another possible method embodiment under the present disclosure. Method 4900 comprises a method for delivering targeted advertisements using location-based financial transactions. Step 4910 is collecting location and transaction data from electric scooters, city bikes, ride-sharing services, and/or digital payment systems in metropolitan areas. Step 4920 is building consumer profiles based on the collected data, including location history and transaction behavior. Step 4930 is delivering targeted advertisements to users based on their current location, recent transaction context, and consumer profile. Method 4900 can comprise a variety of additional, optional, or alternative steps or other variations.

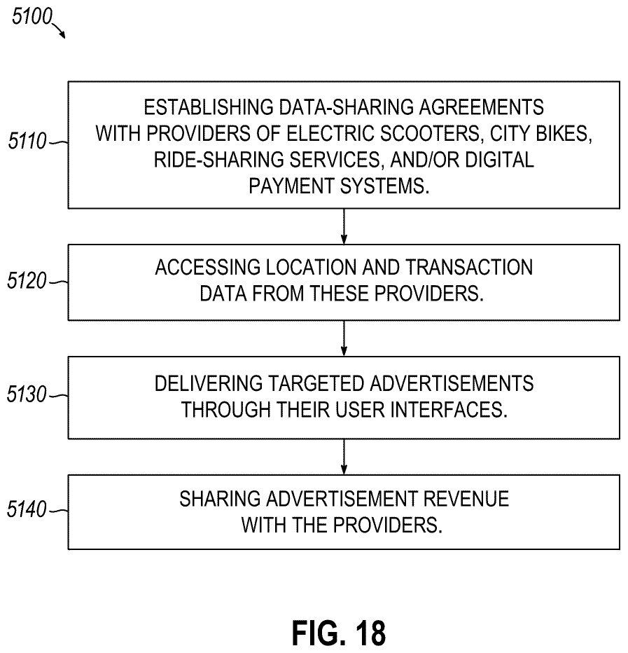

FIG. 18 illustrates another possible method embodiment under the present disclosure. Method 5100 comprises a method for facilitating targeted advertising through partnerships. Step 5110 is establishing data-sharing agreements with providers of electric scooters, city bikes, ride-sharing services, and/or digital payment systems. Step 5120 is accessing location and transaction data from these providers. Step 5130 is delivering targeted advertisements through their user interfaces. Step 5140 is sharing advertisement revenue with the providers. Method 5100 can comprise a variety of additional, optional, or alternative steps or other variations.

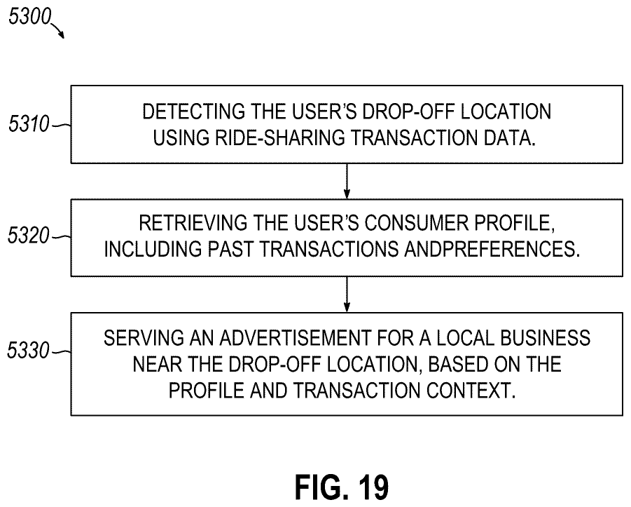

FIG. 19 illustrates another possible method embodiment under the present disclosure. Method 5300 comprises a computer-implemented method for delivering advertisements to a ride-sharing user. Step 5310 is detecting the user's drop-off location using ride-sharing transaction data. Step 5320 is retrieving the user's consumer profile, including past transactions and preferences. Step 5330 is serving an advertisement for a local business near the drop-off location, based on the profile and transaction context. Method 5300 can comprise a variety of additional, optional, or alternative steps or other variations.

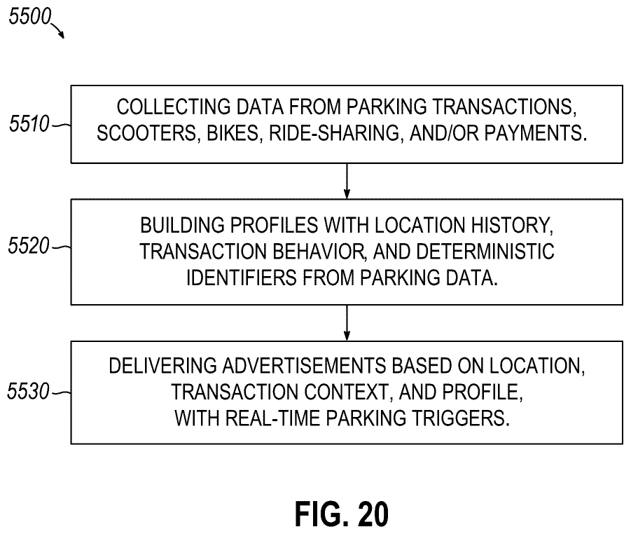

FIG. 20 illustrates another possible method embodiment under the present disclosure. Method 5500 comprises a method for delivering targeted ads using location-based financial transactions, including parking. Step 5510 is collecting data from parking transactions, scooters, bikes, ride-sharing, and/or payments. Step 5520 is building profiles with location history, transaction behavior, and deterministic identifiers from parking data. Step 5530 is delivering advertisements based on location, transaction context, and profile, with real-time parking triggers. Method 5500 can comprise a variety of additional, optional, or alternative steps or other variations.

Although the computing devices described herein (e.g., servers, computing devices, etc. of system 5 of FIG. 1) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” may be the name for a structure that may be well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it may be operable, when executed by one or more processors of the computing system, to cause the computing system to perform one or more functions, such as the functions and methods described herein. Such a structure may be computer-readable directly by a processor—as may be the case if the executable component were binary. Alternatively, the structure may be structured to be interpretable and/or compiled—whether in a single stage or in multiple stages—so as to generate such binary that may be directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that may be well understood by those of ordinary skill in the art of computing.

In terms of computer implementation, a computer may generally be understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Conclusion

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

For any methods and functionalities described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel. In addition, computing devices and other systems described herein may be configured to perform multiple methods described herein simultaneously in parallel.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be affected to the particular embodiments by those of skill in the art without departing from the scope of the description, which is defined solely by the appended claims.

What is claimed is:

1. A parking and advertising system, comprising:
a processor; and
a memory storing instructions whereby the processor is configured to perform the steps of;
detect or predict a location of a consumer;
transmit, to a device of the consumer, a notification of one or more available parking spaces near the location;
receive, from the device, a selection of a parking space of the one or more available parking spaces;
receive, from the device, one or more payment information to pay for the parking space; and
transmit, to the device, one or more marketing materials related to one or more businesses near the location.

2. The system of claim 1, wherein the processor is further configured to perform the step of:
transmit, to the device, one or more payment options to allow for payment by the consumer at the one or more businesses.

3. The system of claim 1, wherein the processor is further operable to:
use artificial intelligence or machine learning model to analyze at least one of: the selection, the one or more businesses, and the one or more marketing materials.

4. The system of claim 1, wherein the processor is further configured to perform the step of:
detect or receive a notification of a parking violation of the consumer.

5. The system of claim 1, wherein the one or more marketing materials are based at least in part on one or more of: a consumer purchase history; a web browser history; a location history of the consumer; a store visited by the consumer.

6. The system of claim 1, wherein the processor is further configured to perform the step of:
transmit, to a digital wallet of the device, a record of the parking space.

7. The system of claim 1, wherein the processor is further configured to perform the step of:
receive, from a computing device, a new location of the consumer, wherein the computing device comprises at least one of: the device; a Wi-Fi router; a Bluetooth device; a near field communication device; a store payment kiosk.

8. The system of claim 1, wherein the processor is further configured to perform the steps of:
detect or receive a location of the consumer;
calculate a travel time for the consumer to return to the parking space; and
if the travel time is longer than a remaining parking time, transmit to the device an option for the consumer to purchase more parking time.

9. A method performed by a parking and advertising system comprising:
detecting or predicting a location of a consumer;
transmitting, to a device of the consumer, a notification of one or more available parking spaces near the location;
receiving, from the device, a selection of a parking space of the one or more available parking spaces;
receiving, from the device, one or more payment information to pay for the parking space; and
transmitting, to the device, one or more marketing materials related to one or more businesses near the location.

10. The method of claim 9, further comprising:
transmitting, to the device, one or more payment options to allow for payment by the consumer at the one or more businesses.

11. The method of claim 9, further comprising:
using artificial intelligence or a machine learning model to analyze at least one of: the selection; the one or more businesses; the one or more marketing materials.

12. The method of claim 9, further comprising:
detecting or receiving a notification of a parking violation of the consumer.

13. The method of claim 12, further comprising:
transmitting, to the device, a notification to make a purchase at the one or more businesses to satisfy the parking violation.

14. The method of claim 9, wherein the one or more marketing materials comprise at least one of: an advertisement for the one or more businesses; a coupon code for the one or more businesses;
an option to make a purchase at the one or more businesses in lieu of paying for the parking space.

15. The method of claim 9, further comprising:
transmitting, to a digital wallet of the device, a record of the parking space.

16. The method of claim 9, further comprising:
detecting or receiving a location of the consumer;
calculating a travel time for the consumer to return to the parking space; and
if the travel time is longer than a remaining parking time, transmitting to the device an option for the consumer to purchase more parking time.

17. A computer implemented method for training a machine learning model for optimizing parking and/or advertising to consumers, the method comprising:
obtaining a first dataset of identified parking and/or advertising outcomes;
training the machine learning model using the first dataset of identified parking and/or advertising outcomes thereby obtaining a trained machine learning model, and
storing the trained machine learning model.

18. The method of claim 17, further comprising:
further training the trained machine learning model using a second dataset of identified parking and/or advertising outcomes, thereby obtaining a further trained machine learning model; and
storing the further trained machine learning model.

19. The method of claim 18, wherein the first dataset of identified parking and/or advertising outcomes and/or second dataset of identified parking and/or advertising outcomes comprise one or more of: customer spend; advertiser spend; number of views by customers; time spent parking; parking spend.

20. The method of claim 17, wherein the machine learning model uses one or more inputs comprising one or more of: business identification; marketing type or characteristic; consumer identification information; location of consumer; location of parking garage; time of day.
